(19) United States
(12) Patent Application Publication
(10) Pub. No.: US 2025/0067438 A1
(43) Pub. Date: Feb. 27, 2025

(54) HEAT SHIELD FOR A GAS TURBINE ENGINE

(71) Applicant: General Electric Company, Schenectady, NY (US)

(72) Inventors: Ravindra Shankar Ganiger, Bengaluru (IN); Hiranya Nath, Bengaluru (IN); Michael A. Benjamin, Cincinnati, OH (US); Michael David Clark, Liberty Township, OH (US)

(21) Appl. No.: 18/536,610

(22) Filed: Dec. 12, 2023

(30) Foreign Application Priority Data
Aug. 23, 2023 (IN) 202311056496

(51) Int. Cl. F23R 3/28; F23D 14/78

(52) U.S. Cl. CPC F23R 3/283; F23D 14/78; F05D 2240/15

(57) ABSTRACT

A heat shield for a combustor of a gas turbine engine. The heat shield includes an annular ring having an axial direction, a radial direction, and a circumferential direction. The annular ring includes a plurality of circumferential segments. Each circumferential segment of the plurality of circumferential segments is disconnected from an adjacent circumferential segment of the plurality of circumferential segments to allow for thermal growth of each circumferential segment during operation of the combustor.

### CROSS REFERENCE TO RELATED APPLICATIONS

The present application claims the benefit of Indian patent application Ser. No. 202311056496, filed on Aug. 23, 2023, which is hereby incorporated by reference herein in its entirety.

### TECHNICAL FIELD

The present disclosure relates to heat shields, particularly, heat shields used for fuel nozzles in combustors, such as, those used in gas turbine engines for aircraft.

### BACKGROUND

Gas turbine engines, particularly, those used in aircraft, are rotary engines having a turbomachine where working air serially flows through a compressor section, a combustor section, and a turbine section. The working air is compressed in the compressor section. The compressed working air is then mixed with fuel and combusted in a combustor of the combustor section, generating hot combustion products. The combustion products are then used to drive turbines of the turbine section. The fuel may be injected into the combustor using a fuel nozzle, and the fuel nozzle may include a heat shield to protect the fuel nozzle from the hot combustion products.

### BRIEF DESCRIPTION OF THE DRAWINGS

Features and advantages of the present disclosure will be apparent from the following description of various exemplary aspects, as illustrated in the accompanying drawings, wherein like reference numbers generally indicate identical, functionally similar, and/or structurally similar elements.

FIG. 1 is a schematic view of an aircraft having a gas turbine engine according to an embodiment of the present disclosure.

FIG. 2 is a schematic, cross-sectional view, taken along line 2-2 in FIG. 1, of the gas turbine engine of the aircraft shown in FIG. 1.

FIG. 3 is a schematic, cross-sectional view of a combustor of the gas turbine engine shown in FIG. 2 according to an embodiment of the present disclosure. FIG. 3 is a detail view showing detail 3 in FIG. 2.

FIG. 4 is a schematic, isometric view of a fuel nozzle (fuel nozzle tip) having a heat shield according to an embodiment of the present disclosure.

FIG. 5 is a partial cross-sectional view of the fuel injector shown in FIG. 4 taken along line 5-5 in FIG. 4.

FIG. 6 is another partial cross-sectional view of the fuel injector shown in FIG. 4 taken along line 6-6 in FIG. 4.

FIG. 7A is a further cross-sectional view of the fuel injector shown in FIG. 4 taken along line 7A-7A in FIG. 4. FIG. 7B shows a variation of a projection, from a perspective similar to the cross-sectional view of FIG. 7A.

FIGS. 8A to 8C show alternatives of the shape of a radial slot and the corresponding projection of the heat shield. FIG. 8A shows a first shape, FIG. 8B shows a second shape, and FIG. 8C shows a third shape.

FIG. 9 is a schematic isometric view of a fuel nozzle having a heat shield according to another embodiment of the present disclosure.

FIG. 10 is a partial cross-sectional view of the fuel nozzle shown in FIG. 9 taken along line 10-10 in FIG. 9.

FIGS. 11A to 11F illustrate a method of manufacturing the heat shield shown in FIG. 9. FIG. 11A is a first step. FIG. 11B is a second step. FIG. 11C is a third step. FIG. 11D is a fourth step. FIG. 11E is a fifth step. FIG. 11F is a sixth step.

FIG. 12 is a partial cross-sectional view showing an alternative geometry of the plates that may be used to form the heat shield shown in FIG. 9.

### DETAILED DESCRIPTION

Features, advantages, and aspects of the present disclosure are set forth or apparent from a consideration of the following detailed description, drawings, and claims. Moreover, the following detailed description is exemplary and intended to provide further explanation without limiting the scope of the disclosure as claimed.

Various aspects are discussed in detail below. While specific aspects are discussed, this is done for illustration purposes only. A person skilled in the relevant art will recognize that other components and configurations may be used without departing from the spirit and the scope of the present disclosure.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or vehicle, and refer to the normal operational attitude of the turbine engine or vehicle. For example, with regard to a turbine engine, forward refers to a position closer to an engine inlet and aft refers to a position closer to an engine nozzle or exhaust.

The terms “coupled,” “fixed,” “attached,” “connected,” and the like, refer to both direct coupling, fixing, attaching, or connecting, as well as, indirect coupling, fixing, attaching, or connecting through one or more intermediate components or features, unless otherwise specified herein.

The singular forms “a,” “an,” and “the” include plural references unless the context clearly dictates otherwise.

Here and throughout the specification and claims, range limitations are combined and interchanged. Such ranges are identified and include all the sub-ranges contained therein, unless context or language indicates otherwise. For example, all ranges disclosed herein are inclusive of the endpoints, and the endpoints are independently combinable with each other.

As used herein, the terms “axial” and “axially” refer to directions and orientations that extend substantially parallel to a centerline, such as, for example, a centerline of the turbine engine or an axis of a fuel nozzle. Moreover, the terms “radial” and “radially” refer to directions and orientations that extend substantially perpendicular to these centerlines. In addition, as used herein, the terms “circumferential” and “circumferentially” refer to directions and orientations that extend arcuately about these centerlines.

References to “inner” and “outer” when discussed in the context of radial directions refer to positions relative to the longitudinal centerline of the component. When referring to a portion of a component and otherwise specified, an “inner portion” preferably refers to an inner half of the component, more preferably, an inner third of the component, and even more preferably, an inner quarter of the component. Likewise, an “outer portion” preferably refers to an outer half of the component, more preferably, an outer third of the component, and even more preferably, an outer quarter of the component.

As used herein, a “hot side” is a side of a component of the turbine engine that is exposed to, or is otherwise oriented to face, a combustion chamber of the combustion section. In the discussion below the hot side of the component may be an aft side or an aft-facing side and thus aft-facing may be used interchangeably with hot side in this context.

As used herein, a “cold side” is a side of the combustion section of the turbine engine that is not exposed to, or otherwise not oriented to face, the combustion chamber. In the discussion below the cold side of the component may be a forward side or a forward-facing side and thus forward-facing may be used interchangeably with cold side in this context.

As noted above, the fuel may be injected into the combustor using a fuel nozzle, and the fuel nozzle may include a heat shield to protect the fuel nozzle from the hot combustion products generated by the combustion of the fuel in the combustor. These heat shields may include an annular metallic ring or a flange positioned on a downstream (combustor facing) end of the fuel nozzle. The metallic flange may be coated with a ceramic thermal barrier coating (TBC) to insulate the underlying substrate. During operation of the combustor, thermal expansion due to elevated temperatures distorts the heat shield and generates hoop stresses in the flange. If the hoop stresses become too large, these hoop stresses can generate radial cracks in the TBC. This cracking may lead to spallation of the TBC and subsequent degradation of the thermal insulation provided by the TBC, resulting in further distortion of the heat shield and a reduction in thermal protection provided by the heat shield. Deterioration of the heat shield may impact the fuel nozzle durability and flame dynamics.

The heat shields discussed herein are circumferentially segmented. This circumferential segmentation reduces (or may even eliminate) the thermal distortion and the hoop stress in the flange of the heat shield, thus reducing cracking and spallation of the TBC. With the circumferentially segmented heat shields discussed herein, the durability the nozzle and flame dynamics in the combustor may be maintained.

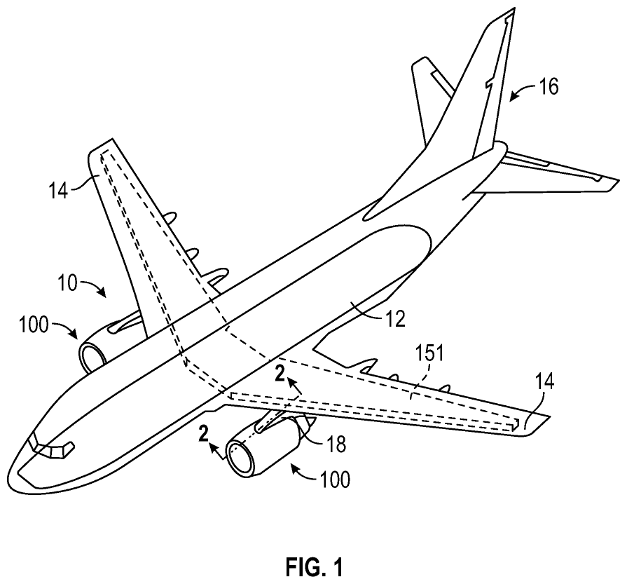

The heat shields discussed herein are particularly suitable for use in engines, such as a gas turbine engine used on an aircraft. FIG. 1 is a perspective view of an aircraft 10 that may implement various preferred embodiments. The aircraft 10 includes a fuselage 12, wings 14 attached to the fuselage 12, and an empennage 16. The aircraft 10 also includes a propulsion system that produces a propulsive thrust required to propel the aircraft 10 in flight, during taxiing operations, and the like. The propulsion system for the aircraft 10 shown in FIG. 1 includes a pair of engines 100. In this embodiment, each engine 100 is attached to one of the wings 14 by a pylon 18 in an under-wing configuration. Although the engines 100 are shown attached to the wing 14 in an under-wing configuration in FIG. 1, in other embodiments, the engine 100 may have alternative configurations and be coupled to other portions of the aircraft 10. For example, the engine 100 may additionally or alternatively include one or more aspects coupled to other parts of the aircraft 10, such as, for example, the empennage 16, and the fuselage 12.

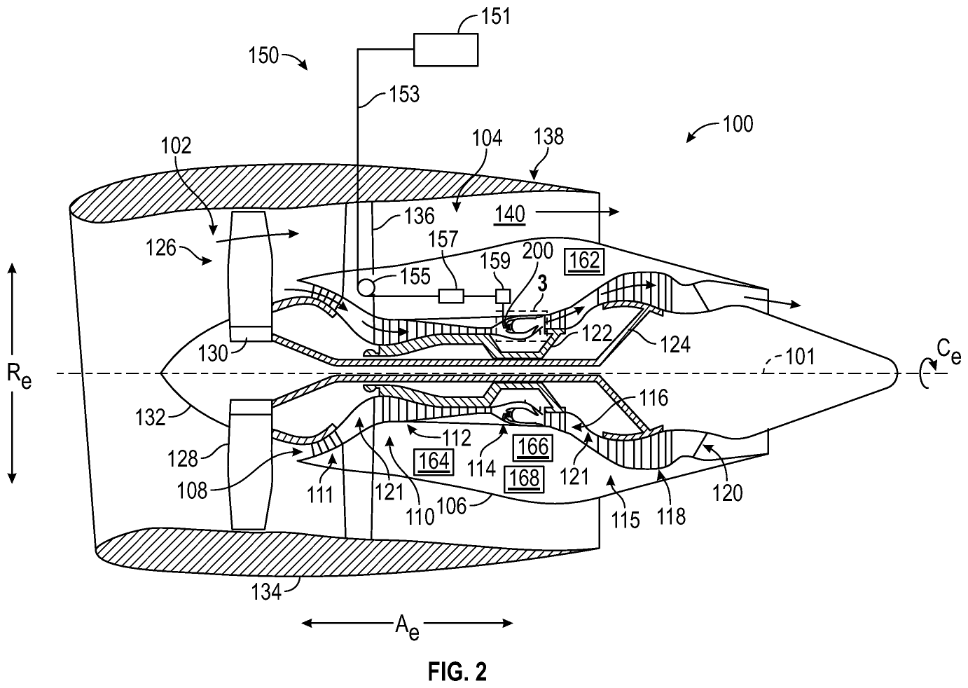

As will be described further below with reference to FIG. 2, the engines 100 shown in FIG. 1 are gas turbine engines that are each capable of selectively generating a propulsive thrust for the aircraft 10. The amount of propulsive thrust may be controlled at least in part based on a volume of fuel provided to the engines 100 via a fuel system 150 (see FIG. 2). An aviation turbine fuel used in the embodiments discussed herein may be a combustible hydrocarbon liquid fuel, such as a kerosene-type fuel, having a desired carbon number, for example, JetA fuel. But other suitable fuels may be used including, for example, sustainable aviation fuels (SAF), including biofuels, hydrogen-based fuel (H2), and the like. The fuel is stored in a fuel tank 151 of the fuel system 150. As shown in FIG. 1, at least a portion of the fuel tank 151 is located in each wing 14 and a portion of the fuel tank 151 is located in the fuselage 12 between the wings 14. The fuel tank 151, however, may be located at other suitable locations in the fuselage 12 or the wing 14. The fuel tank 151 may also be located entirely within the fuselage 12 or the wing 14. The fuel tank 151 may also be separate tanks instead of a single, unitary body, such as, for example, two tanks each located within a corresponding wing 14.

Although the aircraft 10 shown in FIG. 1 is an airplane, the embodiments described herein may also be applicable to other aircraft 10, including, for example, helicopters and unmanned aerial vehicles (UAV). Preferably, the aircraft discussed herein are fixed-wing aircraft or rotor aircraft that generate lift by aerodynamic forces acting on, for example, a fixed wing (e.g., wing 14) or a rotary wing (e.g., a rotor of a helicopter), and are heavier-than-air aircraft, as opposed to lighter-than-air aircraft (such as a dirigible). Further, although not depicted herein, in other embodiments, the gas turbine engine may be any other suitable type of gas turbine engine, such as an industrial gas turbine engine incorporated into a power generation system, a nautical gas turbine engine, etc.

FIG. 2 is a schematic, cross-sectional view of one of the engines 100 used in the propulsion system for the aircraft 10 shown in FIG. 1. The cross-sectional view of FIG. 2 is taken along line 2-2 in FIG. 1. For the embodiment depicted in FIG. 2, the engine 100 is a high bypass turbofan engine. The engine 100 may also be referred to as a turbofan engine herein. The engine 100 has an axial direction (engine axial direction Aₑ) (extending parallel to a longitudinal centerline 101, shown for reference in FIG. 2), a radial direction (engine radial direction Rₑ), and a circumferential direction (engine circumferential direction Cₑ). The engine circumferential direction Cₑ extends in a direction rotating about the engine axial direction Aₑ. The turbofan engine (engine 100) includes a fan section 102 and a turbomachine 104 disposed downstream from the fan section 102.

The turbomachine 104 depicted in FIG. 2 includes a tubular outer casing 106 (also referred to as a housing or a nacelle) that defines an inlet 108. In this embodiment, the inlet 108 is annular. The outer casing 106 encases an engine core that includes, in a serial flow relationship, a compressor section 110 including a booster or a low-pressure (LP) compressor 111 and a high-pressure (HP) compressor 112, a combustion section 114, a turbine section 115 including a high-pressure (HP) turbine 116 and a low-pressure (LP) turbine 118, and a jet exhaust nozzle section 120. The compressor section 110, the combustion section 114, and the turbine section 115 together define at least in part a core air flowpath 121 extending from the inlet 108 to the jet exhaust nozzle section 120. The turbofan engine further includes one or more drive shafts. More specifically, the turbofan engine includes a high-pressure (HP) shaft or spool 122 drivingly connecting the HP turbine 116 to the HP compressor 112, and a low-pressure (LP) shaft or a spool 124 drivingly connecting the LP turbine 118 to the LP compressor 111.

The fan section 102 shown in FIG. 2 includes a fan 126 having a plurality of fan blades 128 coupled to a disk 130. The plurality of fan blades 128 and the disk 130 are rotatable, together, about the longitudinal centerline (axis) 101 by the LP shaft 124. The LP compressor 111 may also be directly driven by the LP shaft 124, as depicted in FIG. 2. The disk 130 is covered by a rotatable front hub 132 aerodynamically contoured to promote an airflow through the plurality of fan blades 128. Further, an annular fan casing or an outer nacelle 134 is provided, circumferentially surrounding the fan 126 and/or at least a portion of the turbomachine 104. The nacelle 134 is supported relative to the turbomachine 104 by a plurality of circumferentially spaced outlet guide vanes 136. A downstream section 138 of the nacelle 134 extends over an outer portion of the turbomachine 104 so as to define a bypass airflow passage 140 therebetween.

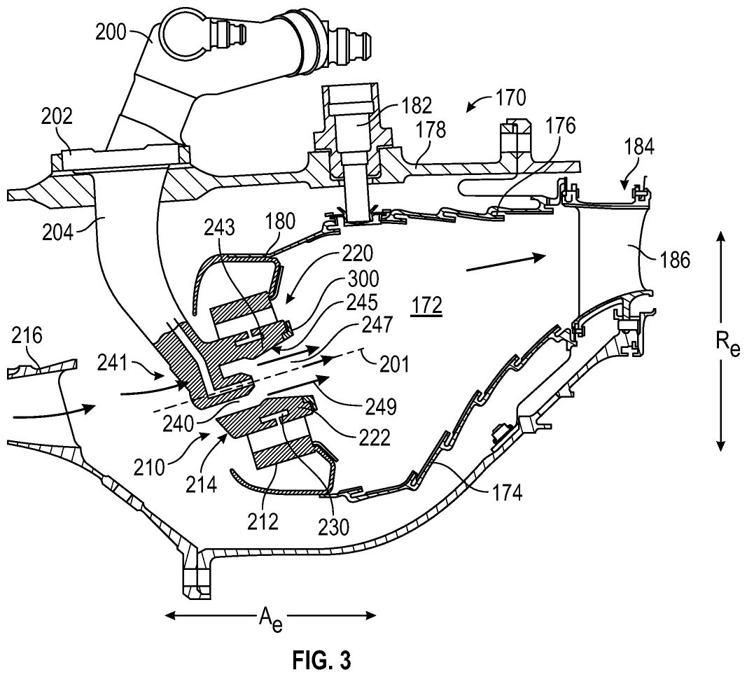

The engine 100 is operable with the fuel system 150 and receives a flow of fuel from the fuel system 150. The fuel system 150 includes a fuel delivery assembly 153 providing the fuel flow from the fuel tank 151 to the engine 100, and, more specifically, to a plurality of fuel injectors 200 that inject fuel into a combustion chamber 172 of a combustor 170 (see FIG. 3, discussed further below) of the combustion section 114. The fuel injector may also be referred to generally as a fuel nozzle. The components of the fuel system 150, and, more specifically, the fuel tank 151, is an example of a fuel source that provides fuel to the fuel injectors 200, as discussed in more detail below. The fuel delivery assembly 153 includes tubes, pipes, conduits, and the like, to fluidly connect the various components of the fuel system 150 to the engine 100. The fuel tank 151 is configured to store the fuel, and the fuel is supplied from the fuel tank 151 to the fuel delivery assembly 153. The fuel delivery assembly 153 is configured to carry the fuel between the fuel tank 151 and the engine 100 and, thus, provides a flow path (fluid pathway) of the fuel from the fuel tank 151 to the engine 100.

The fuel system 150 includes at least one fuel pump fluidly connected to the fuel delivery assembly 153 to induce the flow of the fuel through the fuel delivery assembly 153 to the engine 100. One such pump is a main fuel pump 155. The main fuel pump 155 is a high-pressure pump that is the primary source of pressure rise in the fuel delivery assembly 153 between the fuel tank 151 and the engine 100. The main fuel pump 155 may be configured to increase a pressure in the fuel delivery assembly 153 to a pressure greater than a pressure within the combustion chamber 172 of the combustor 170.

The fuel system 150 also includes a fuel metering unit 157 in fluid communication with the fuel delivery assembly 153. Any suitable fuel metering unit 157 may be used including, for example, a metering valve. The fuel metering unit 157 is positioned downstream of the main fuel pump 155 and upstream of a fuel manifold 159 configured to distribute fuel to the fuel injectors 200. The fuel system 150 is configured to provide the fuel to the fuel metering unit 157, and the fuel metering unit 157 is configured to receive fuel from the fuel tank 151. The fuel metering unit 157 is further configured to provide a flow of fuel to the engine 100 in a desired manner. More specifically, the fuel metering unit 157 is configured to meter the fuel and to provide a desired volume of fuel, at, for example, a desired flow rate, to the fuel manifold 159 of the engine 100. The fuel manifold 159 is fluidly connected to the fuel injectors 200 and distributes (provides) the fuel received to the plurality of fuel injectors 200, where the fuel is injected into the combustion chamber 172 and combusted. Adjusting the fuel metering unit 157 changes the volume of fuel provided to the combustion chamber 172 and, thus, changes the amount of propulsive thrust produced by the engine 100 to propel the aircraft 10.

The engine 100 also includes various accessory systems to aid in the operation of the engine 100 and/or an aircraft, that includes the engine 100. For example, the engine 100 may include a main lubrication system 162, a compressor cooling air (CCA) system 164, an active thermal clearance control (ATCC) system 166, and a generator lubrication system 168, each of which is depicted schematically in FIG. 2. The main lubrication system 162 is configured to provide a lubricant to, for example, various bearings and gear meshes in the compressor section 110, the turbine section 115, the HP spool 122, and the LP shaft 124. The lubricant provided by the main lubrication system 162 may increase the useful life of such components and may remove a certain amount of heat from such components through the use of one or more heat exchangers. The compressor cooling air (CCA) system 164 provides air from one or both of the HP compressor 112 or the LP compressor 111 to one or both of the HP turbine 116 or the LP turbine 118. The active thermal clearance control (ATCC) system 166 acts to minimize a clearance between tips of turbine blades and casing walls as casing temperatures vary during a flight mission. The generator lubrication system 168 provides lubrication to an electronic generator (not shown), as well as cooling/heat removal for the electronic generator. The electronic generator may provide electrical power to, for example, a startup electrical motor for the engine 100 and/or various other electronic components of the engine 100 and/or an aircraft that includes the engine 100. The lubrication systems for the engine 100 (e.g., the main lubrication system 162 and the generator lubrication system 168) may use hydrocarbon fluids, such as oil, for lubrication, in which the oil circulates through inner surfaces of oil scavenge lines.

The turbofan engine (engine 100) discussed herein is provided by way of example only. In other embodiments, any other suitable engine may be utilized with aspects of the present disclosure. For example, in other embodiments, the engine 100 may be any other suitable gas turbine engine, such as a turboshaft engine, a turboprop engine, a turbojet engine, an unducted single fan engine, and the like. In such a manner, it will further be appreciated that, in other embodiments, the gas turbine engine may have other suitable configurations, such as other suitable numbers or arrangements of shafts, compressors, turbines, fans, etc. Further, although the turbofan engine (engine 100) is shown as a direct drive, fixed-pitch turbofan engine, in other embodiments, a gas turbine engine may be a geared gas turbine engine (i.e., including a gearbox between the fan 126 and shaft driving the fan, such as the LP shaft 124), may be a variable pitch gas turbine engine (i.e., including a fan 126 having a plurality of fan blades 128 rotatable about their respective pitch axes), etc. Further, still, in alternative embodiments, aspects of the present disclosure may be incorporated into, or otherwise utilized with any other type of engine, such as reciprocating engines. Additionally, in still other exemplary embodiments, the exemplary turbofan engine (engine 100) may include or be operably connected to any other suitable accessory systems. Additionally, or alternatively, the exemplary engine 100 may not include or be operably connected to one or more of the accessory systems 162, 164, 166, and 168, discussed above.

FIG. 3 is a schematic, cross-sectional view of the combustor 170 of the combustion section 114 according to an embodiment of the present disclosure. Specifically, FIG. 3 is a detail view showing detail 3 in FIG. 2. The combustor 170 is an annular combustor that includes a combustion chamber 172 defined between an inner liner 174 and an outer liner 176. Each of the inner liner 174 and outer liner 176 is annular about the longitudinal centerline 101 of the engine 100 (FIG. 2), and may thus extend in the engine circumferential direction Cₑ. The combustor 170 also includes a combustor case 178 that is also annular about the longitudinal centerline 101 of the engine 100. The combustor case 178 extends circumferentially around the inner liner 174 and the outer liner 176, and the inner liner 174 and outer liner 176 are located radially inward of the combustor case 178. The combustor 170 also includes a dome 180 mounted to a forward end of each of the inner liner 174 and the outer liner 176. The dome 180 defines an upstream (or forward end) of the combustion chamber 172.

A plurality of mixer assemblies 210 (only one is illustrated in FIG. 3) are spaced around the dome 180. The plurality of mixer assemblies 210 are circumferentially spaced about the longitudinal centerline 101 of the engine 100. In the embodiment shown in FIG. 3, each mixer assembly 210 is a twin annular premixing swirler (TAPS) that includes a main mixer 212 and a pilot mixer 214. The pilot mixer 214 is supplied with fuel from the fuel injector 200 during the entire engine operating cycle, and the main mixer 212 is supplied with fuel from the fuel injector 200 only during increased power conditions of the engine operating cycle, such as take-off and climb, for example. As discussed in more detail below, fuel injector 200 includes an aft heat shield 300. The TAPS mixer assembly 210 is provided by way of example and aft heat shield 300 herein may be used with other mixer assembly designs and other combustor designs, including, for example, rich burn combustors and mixer assemblies.

As noted above, the compressor section 110, including the HP compressor 112 (FIG. 2), pressurizes air, and the combustor 170 receives an annular stream of this pressurized air from a discharge outlet (compressor discharge outlet 216) of the HP compressor 112. This air may be referred to as compressor discharge air. A portion of the compressor discharge air flows into the mixer assembly 210. Fuel is injected into the air in the mixer assembly 210 to mix with the air and to form a fuel-air mixture. The fuel-air mixture is provided to the combustion chamber 172 from the mixer assembly 210 for combustion. Ignition of the fuel-air mixture is accomplished by a suitable igniter 182, and the resulting combustion gases flow in the engine axial direction Aₑ toward and into an annular, first stage turbine nozzle 184. The first stage turbine nozzle 184 is defined by an annular flow channel that includes a plurality of radially extending, circularly-spaced nozzle vanes 186 that turn the gases so that they flow angularly and impinge upon the first stage turbine blades (not shown) of a first turbine (not shown) of the HP turbine 116 (FIG. 2).

The fuel injector 200 is fixed to the combustor case 178 by a nozzle mount. In this embodiment, the nozzle mount is a flange 202 that is integrally formed with a stem 204 of the fuel injector 200. The flange 202 is fixed to the combustor case 178 and sealed to the combustor case 178. The stem 204 includes a flow passage through which the fuel flows, and the stem 204 extends radially inward from the flange 202. The fuel injector 200 also includes a fuel nozzle tip 220 through which fuel is injected into the combustion chamber 172 as part of the mixer assembly 210.

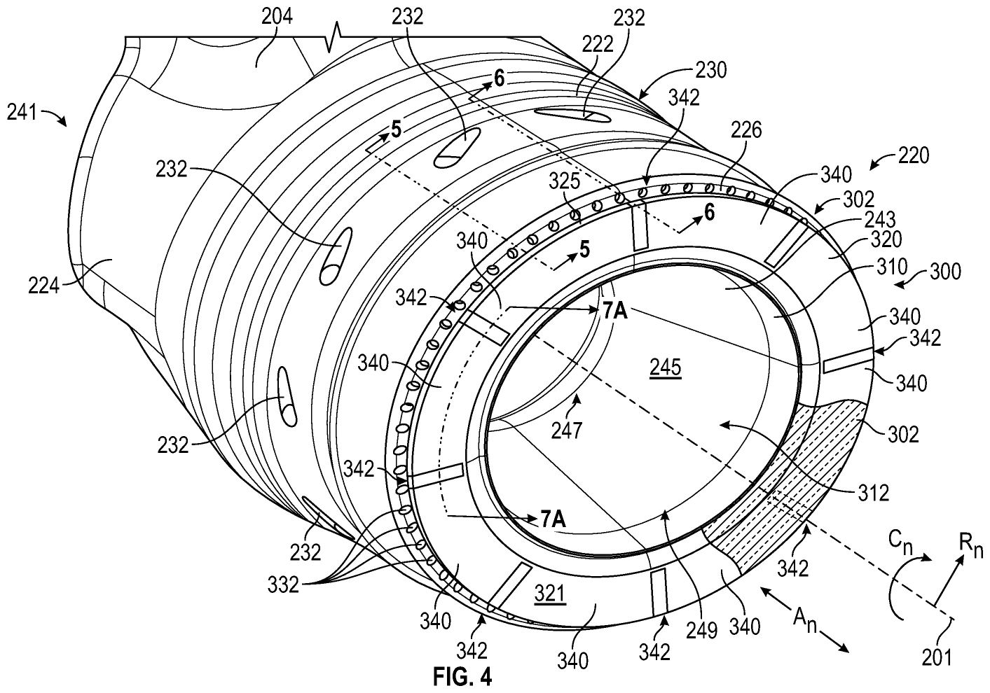

FIG. 4 is a schematic isometric view showing the fuel nozzle tip 220 (more generally, referred to as a fuel nozzle) of the fuel injector 200. The fuel nozzle tip 220 includes a fuel nozzle body 222 and an aft heat shield 300 according to an embodiment. The aft heat shield 300 is attached to the fuel nozzle body 222. The fuel nozzle body 222 is mounted to an inlet fairing 224. The inlet fairing 224 is connected to or integral with the stem 204. The fuel nozzle body 222 includes a main fuel nozzle 230 and a dual orifice pilot fuel injector tip 240 (see FIG. 3) having a primary pilot fuel orifice and a secondary pilot fuel orifice.

As can be seen in FIG. 3, the dual orifice pilot fuel injector tip 240 may be substantially centered in an annular pilot inlet 241. The main fuel nozzle 230 surrounds the pilot inlet 241, and the pilot inlet 241 is located between the main fuel nozzle 230 and the dual orifice pilot fuel injector tip 240. In this embodiment, the fuel nozzle tip 220 is circular about an axis (referred to herein as a fuel nozzle axis 201) extending through the center of the primary pilot fuel orifice. In the discussion below, various features of the fuel nozzle tip 220 may be discussed relative to this axis (the fuel nozzle axis 201).

Fuel is provided through the stem 204 to the primary pilot fuel orifice and the secondary pilot fuel orifice of the dual orifice pilot fuel injector tip 240. The pilot mixer 214 includes pilot swirlers causing air traveling therethrough to swirl. A portion of the compressor discharge air flows into the mixer assembly pilot inlet 241 and then, into the pilot swirlers. As noted above, fuel and air are provided to the pilot mixer 214 at all times during the engine operating cycle so that a primary combustion zone is produced within a central portion of the combustion chamber 172. Each of the primary pilot fuel orifice and the secondary pilot fuel orifice injects fuel in a generally downstream direction and into the compressed air flowing through the pilot swirlers. The pilot mixer 214 is supported by an annular pilot housing 243. The pilot housing 243 includes a conical wall section 245 circumscribing a conical pilot mixing chamber 247 that is in flow communication with, and downstream from, the pilot mixer 214. The fuel and air mixture flows through the pilot mixing chamber 247, where the fuel and air are further mixed, through an outlet 249 of the pilot mixing chamber 247, and into the combustion chamber 172 (see FIG. 3).

Referring back to FIG. 4, fuel also is provided through the stem 204 to the main fuel nozzle 230 and, more specifically, to an annular main fuel passage of an annular main fuel ring. The main fuel nozzle 230 includes a circular array of main fuel injection orifices 232 (or an annular array of main fuel injection orifices 232) extending radially outward from the annular main fuel passage and through the wall of the annular main fuel ring. The main fuel nozzle 230 and the annular main fuel ring are spaced radially outward of the primary pilot fuel orifice and the secondary pilot fuel orifice. The main fuel nozzle 230 injects fuel in a radially outward direction through the circular array of main fuel injection orifices 232.

As noted above, the fuel nozzle tip 220 includes the fuel nozzle axis 201, and various features of the fuel nozzle tip 220 may be discussed relative to the fuel nozzle axis 201. The fuel nozzle (fuel nozzle tip 220) has an axial direction (a nozzle axial direction Aₙ) (extending parallel to the fuel nozzle axis 201), a radial direction (a nozzle radial direction Rₙ), and a circumferential direction (a nozzle circumferential direction Cₙ). The nozzle circumferential direction Cₙ extends in a direction rotating about the nozzle axial direction Aₙ.

The fuel nozzle tip 220 extends into the combustion chamber 172 and is adjacent to the primary combustion zone. The pilot housing 243, and the aft heat shield 300 are exposed to high temperatures. For example, the conical wall section 245 of the pilot housing 243 and the aft heat shield 300 may be exposed to gas temperatures from six hundred degrees Fahrenheit (600° F.) to three thousand eight hundred degrees Fahrenheit (3,800° F.). The pilot housing 243 and the aft heat shield 300 are made from materials suitable for use in these high temperature environments including, for example, stainless steel, corrosion-resistant alloys of nickel and chromium, and high-strength nickel-base alloys. The pilot housing 243 and the aft heat shield 300 may thus be formed from a metal alloy chosen from the group consisting of iron-based alloys, nickel-based alloys, and chromium-based alloys. In some embodiments, cobalt-based alloys may also be used.

The aft heat shield 300 includes an inner wall 310. The inner wall 310 may be annular defining a heat-shield bore 312. The inner wall 310 may be an axially extending sidewall that extends in the nozzle axial direction Aₙ into the pilot mixing chamber 247. The inner wall 310 may form a portion of the conical wall section 245, and a forward end of inner wall 310 may abut an aft end the conical wall section 245 to provide a generally continuous conical section of the pilot mixing chamber 247 with the heat-shield bore 312 forming a portion of the pilot mixing chamber 247. The inner wall 310 may be attached to the pilot housing 243 to connect the aft heat shield 300 to the fuel nozzle tip 220. The inner wall 310 may be attached to the pilot housing 243 by any suitable means including, for example, fusion bonding processes, such as brazing, welding, or the like. The aft heat shield 300 also includes a shield flange 320 at an aft end of the inner wall 310. The shield flange 320 is annular and extends radially outward from the fuel nozzle axis 201, and may be referred to herein as an annular ring. The shield flange 320 may include an aft-facing surface 321. The aft-facing surface 321 is a surface facing the combustion chamber 172 and is, thus, a hot-side surface. The aft-facing surface 321 of this embodiment is a generally planar surface.

In this embodiment, the aft-facing surface 321 is orthogonal to the fuel nozzle axis 201 and the aft-facing surface 321 may be coated with a thermal barrier coating (TBC) 302 to insulate the fuel nozzle tip 220 from the heat from combustion. To show features of the aft heat shield 300, the TBC 302 is only shown in FIG. 4 on a portion of the aft-facing surface 321. Preferably, the TBC 302 is a coating with a high thermal resistivity, such as ceramic materials. The ceramic may be a stabilized ceramic that can sustain a fairly high temperature gradient such that the coated metallic components can be operated at gas temperatures higher than the melting point of the metal. For instance, the TBC material may be one or more of yttria stabilized zirconia (YSZ) and other rare-earth-stabilized zirconia compositions, mullite (3Al₂O₃—2SiO₂), alumina (Al₂O₃), ceria (CeO₂), rare-earth zirconates (e.g., La₂Zr₂O₇), rare-earth oxides (e.g., La₂O₃, Nb₂O₅, Pr₂O₃, CeO₂), and metal-glass composites, including combinations thereof (e.g., alumina and YSZ or ceria and YSZ). One particularly suitable TBC material is, for example, yttria-stabilized zirconia (YSZ).

As noted above, a portion of the compressor discharge air flows into the mixer assembly 210 (FIG. 3). While some of the compressor discharge air is mixed with the fuel to form the fuel and air mixture being discharged from the outlet 249, another portion of the compressor discharge air may be used as cooling air for the aft heat shield 300. The cooling air may be discharged from a plurality of cooling holes 332 formed in an aft-facing surface 226 of the fuel nozzle body 222. The aft-facing surface 226 may be referred to herein as a distal end of the fuel nozzle tip 220. For clarity, only a portion of the cooling holes 332 is indicated by a reference numeral in FIG. 4 and the following discussion.

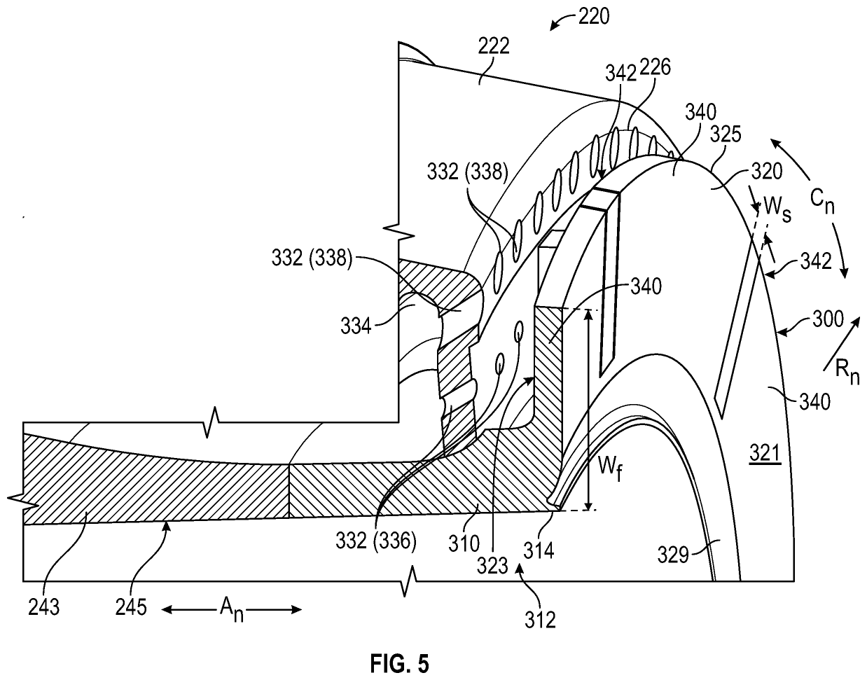

FIG. 5 is a partial cross-sectional view of the fuel nozzle tip 220 taken along line 5-5 in FIG. 4. The fuel nozzle body 222 may include an annular cooling air passage 334 formed forward of the aft-facing surface 226 and through which cooling air flows. The cooling holes 332 are fluidly connected to the cooling air passage 334 and the cooling air discharged from the cooling air passage 334 is directed toward a forward-facing surface 323 of the shield flange 320. The forward-facing surface 323 is a surface on an opposite side of the shield flange 320 from the aft-facing surface 321 and is, thus, a cold-side surface. Although the forward-facing surface 323 is shown as a planar surface in FIG. 5, the forward-facing surface 323 is not so limited and may include fins, as discussed further below, for example. The cooling holes 332 may be arranged in two arrays (an inner array 336 and an outer array 338). The cooling holes 332 in each of the inner array 336 and the outer array 338 are aligned in the circumferential Cₙ direction and circumferentially spaced, preferably, uniformly, about the fuel nozzle axis 201 (see FIG. 4). The cooling holes 332 of the inner array 336 may be oriented in the nozzle axial direction Aₙ. parallel to the fuel nozzle axis 201, and the cooling holes 332 of the outer array 338 may be angled with respect to the fuel nozzle axis 201 and oriented (aimed) to impinge cooling air on or near a radially outer annular flange tip 325 of shield flange 320. The flange tip 325 of this embodiment is a radially outer edge, and, more specifically, a radially outermost edge of the shield flange 320.

The shield flange 320 of this embodiment extends from the heat-shield bore 312 outward in the radial direction Rₙ of the fuel nozzle tip 220. More specifically, in this embodiment, the normal of the aft-facing surface 321 is parallel to the nozzle axial direction Aₙ of the fuel nozzle tip 220. The shield flange 320 is annular and extends in the circumferential direction Cₙ of the fuel nozzle tip 220. During operation, the shield flange 320 heats up and grows (i.e., increases in physical size) due to thermal expansion. To alleviate hoop stresses, the shield flange 320 includes a plurality of radial slots 342, forming a plurality of circumferential segments 340 of the shield flange 320. Each circumferential segment 340 of the plurality of circumferential segments 340 is disconnected from an adjacent circumferential segment 340 of the plurality of circumferential segments 340. In this embodiment, adjacent circumferential segments 340 of the plurality of circumferential segments 340 are disconnected from each other by one of the radial slots 342. The radial slots 342 reduce the constraint of the shield flange 320 on itself and allow each circumferential segment 340 of the plurality of the circumferential segments 340 to move independently of each other. More specifically, the radial slots 342 may allow both axial and radial growth of each circumferential segment 340, reducing hoop stress.

In this embodiment, each radial slot 342 is cut (extends) inward from the flange tip 325 toward the inner wall 310. The shield flange 320 includes an inner ring portion 329, which, in this embodiment, is the inner portion of the shield flange 320 that is free from the radial slots 342. Each circumferential segment 340 extends radially outward from the inner ring portion 329 with the radial slot 342 separating the circumferential segments 340.

The shield flange 320 has a width W_{f} that is the distance from the flange tip 325 to an inner diametrical edge 314 of the shield flange 320. The width W_{f} may be referred to as the flange width or the radial width herein. The radial slots 342 may extend all the way through the shield flange 320 to the heat-shield bore 312, but preferably, the radial slots 342 do not extend all the way through the shield flange 320 to the heat-shield bore 312. The longer the radial slot 342, the more hoop stresses can be reduced and thus the greatest amount of hoop stress reduction occurs when the radial slot 342 extends all the way through the shield flange 320. These longer slots, however, reduce the structural rigidity of the shield flange 320 and a discontinuity at the inner wall 310 may impact flame dynamics and thus, preferably, the radial slots 342 do not extend all the way through the shield flange 320 to the heat-shield bore 312. Also, a certain minimum amount of hoop stress reduction is needed to avoid cracking in the TBC 302 (see FIG. 4). This hoop stress reduction may depend on the thermal gradients on the shield flange 320. Balancing these considerations, the radial slots 342, thus, may extend from ten percent (10%) to one hundred percent (100%) of the flange width W_{f}, and, more preferably, from twenty percent (20%) to eighty percent (80%).

The shield flange 320 also includes a flange thickness at the location where the radial slot 342 is formed. The radial slot 342 is preferably formed through the entire flange thickness. Each radial slot 342 also includes a slot width Wₛ (a width in the circumferential direction). Narrow and tightly toleranced slots are difficult to manufacture, and thus, in this embodiment, the slot width Wₛ is at least fifty thousandths of an inch (50 mils). Preferably, the slot width Wₛ is from fifty thousandths of an inch (50 mils) to two hundred thousandths of an inch (200 mils), and, more preferably, the slot width Wₛ is from eighty-five thousandths of an inch (85 mils) to one hundred seventy-five thousandths of an inch (175 mils).

As shown in FIG. 4, the radial slots 342 are uniformly spaced apart from each other. In this embodiment, the shield flange 320 has eight circumferential segments 340, with each radial slots 342 being located forty-five degrees (45 degrees) from each other. The shield flange 320 preferably includes a minimum of two circumferential segments 340, with the radial slots 342 being circumferentially spaced one hundred eighty degrees (180 degrees) from each other, but, in other embodiments, the shield flange 320 may include four circumferential segments 340, with the radial slots 342 being circumferentially spaced ninety degrees (90 degrees) from each other. In still further embodiments, the plurality of circumferential segments 340 may be more than eight with a corresponding uniform circumferential spacing of the radial slots 342.

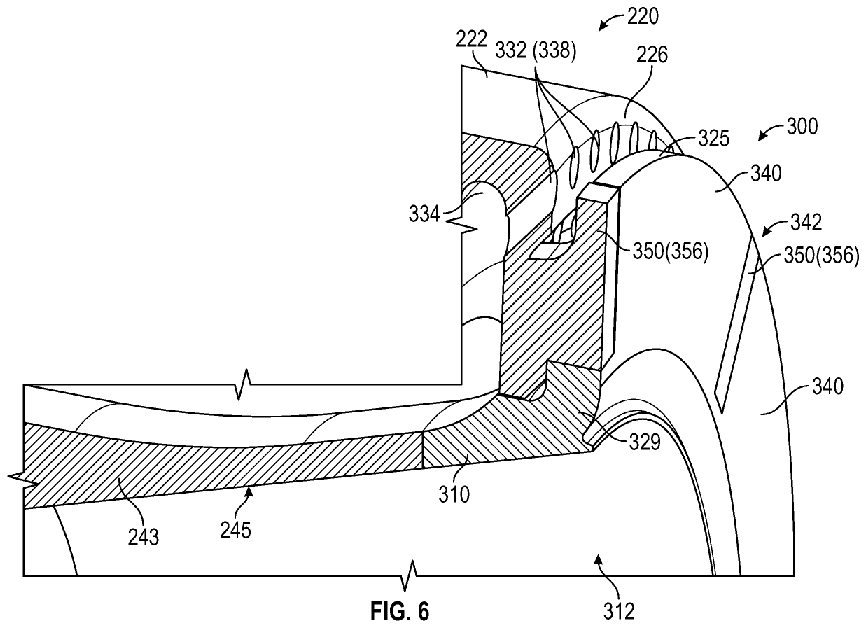

FIG. 6 is another partial cross-sectional view of the fuel nozzle tip 220, taken along line 6-6 in FIG. 4. As noted above, the radial slots 342 are relatively wide, which aids in manufacturing. With such a wide radial slot 342, heat may pass through the slot, and the aft heat shield 300 of this embodiment includes a slot filler 356 positioned in each of the radial slots 342 to prevent heat from passing through the radial slots 342. The slot filler 356 may be attached to a structure on the cold side of the shield flange 320. In this embodiment, the slot filler 356 is a projection 350 extending from the aft-facing surface 226 of the fuel nozzle body 222. The projections 350 are positioned on the aft-facing surface 226 to extend into the radial slots 342 and, thus, may be arranged in a manner similar to the radial slots 342, as discussed above. The projections 350 may be integrally formed with the fuel nozzle body 222 or be separate components attached to the fuel nozzle body 222 by suitable means such as a fusion bonding process like welding. The projection 350 may the same material, such as a metal, as the fuel nozzle body 222 or be a metal that is compatible with the material of the fuel nozzle body 222 (e.g., weldable to the fuel nozzle body 222 and having similar thermal properties). The projection 350 may thus be formed from a metal alloy chosen from the group consisting of iron-based alloys, nickel-based alloys, and chromium-based alloys. In some embodiments, cobalt-based alloys may also be used.

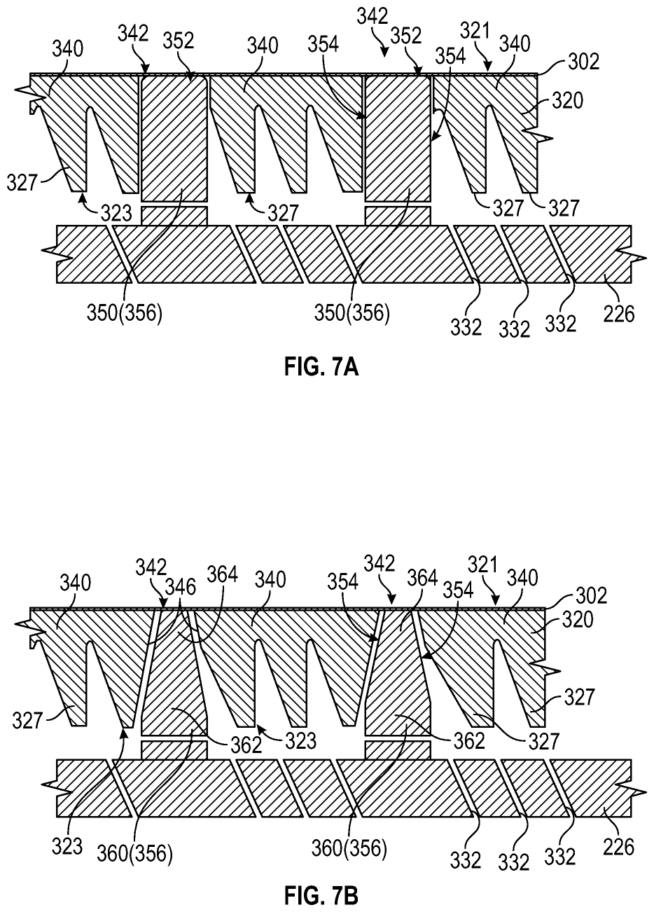

FIG. 7A is further partial cross-sectional view of the shield flange 320 taken along line 7A-7A in FIG. 4. Each projection 350 includes an aft-facing surface 352, and, in this embodiment, the projection 350 extends into the radial slot 342 such that the aft-facing surface 352 of the projection 350 is substantially coplanar with the aft-facing surface 321 of the shield flange 320. The aft-facing surface 352 of the projection 350 may be flush with the with the aft-facing surface 321 of the shield flange 320, and the surfaces may be machined to obtain such a condition. With the aft-facing surface 352 of the projection 350 substantially coplanar with the aft-facing surface 321 of the shield flange 320, the TBC 302 can be applied using a suitable method such as chemical vapor deposition, to form an even layer of the ceramic of the TBC 302 over the combustor-facing surfaces of each of the shield flange 320 and the projection 350. The projection 350 includes side surfaces 354. In this embodiment, the side surfaces 354 extend perpendicular to the aft-facing surface 226 of the fuel nozzle body 222, and, thus, the projection 350 has a rectangular cross section in a circumferential plane.

As noted above, cooling air is directed from the cooling holes 332 toward the forward-facing surface 323 of the shield flange 320. To increase the surface area exposed to the cooling air and, thus, increase the cooling effect, a plurality of fins 327 is formed on the forward-facing surface 323 of each of the circumferential segments 340. The fins 327 may have any suitable shape, including, for example, an axially-tapered shape.

FIG. 7B is a partial cross-sectional view similar to the partial cross-sectional view of FIG. 7A. Instead of the slot filler 356 being the projection 350 having a rectangular cross section in a circumferential plane, the slot filler 356 may have other cross-sectional shapes. FIG. 7B shows another projection 360 that is axially tapered instead of having a rectangular cross section in the circumferential plane. The projection 360 shown in FIG. 7B is otherwise similar to the projection 350 shown in FIG. 7A, and the discussion of the projection 350 and features of the shield flange 320 also apply here. The same reference numerals are used for the same or similar components of the projection 360 and the shield flange 320 shown in FIG. 7B as for the projection 350 and the shield flange 320 discussed above. The projection 360 is axially tapered having a width that gets narrower moving from the aft-facing surface 226 of the fuel nozzle body 222 toward the aft-facing surface 321 of the shield flange 320. The projection 360 may have a proximal portion 362 of the projection 360 that is proximate the aft-facing surface 226 of the fuel nozzle body 222 and a distal portion 364 of the projection 360 that is distal from the aft-facing surface 226 of the fuel nozzle body 222. The projection 360 may be tapered such that the proximal portion 362 of the projection 360 is wider than the distal portion 364 of the projection. Side walls 346 of the radial slot 342 also have a corresponding axial taper with the width of the radial slot 342 at the aft-facing surface 321 being narrower than the width of the radial slot 342 at the forward-facing surface 323. With the taper, the projections 360 resist movement of each of the circumferential segments 340 in the forward direction. As the circumferential segment 340 moves forward, the side walls 346 of the radial slot 342 contact the side surfaces 354 of the projection 360, resisting movement.

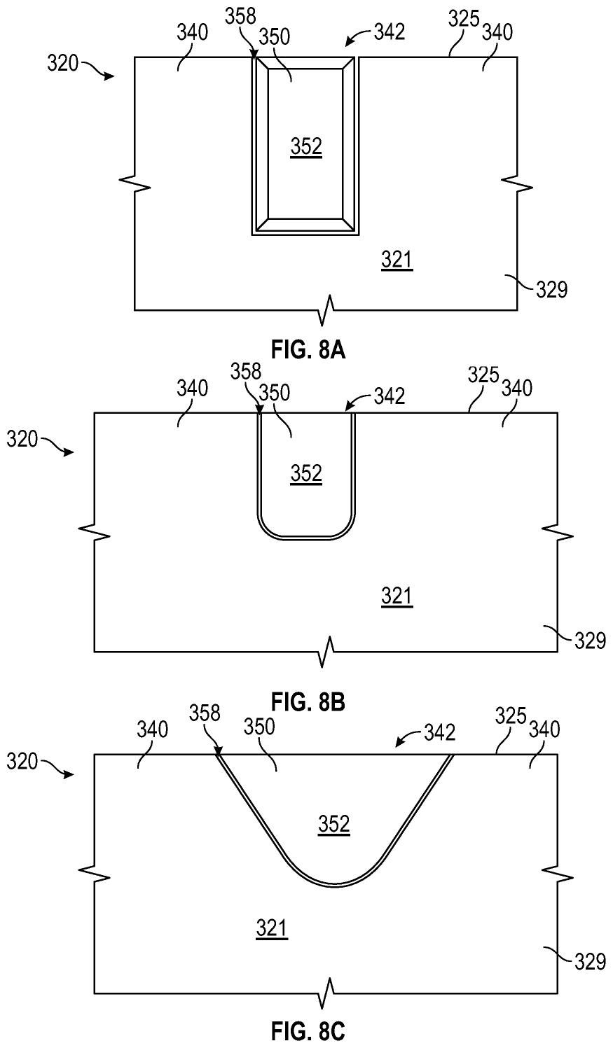

FIG. 8A shows the aft-facing surface 321 of the shield flange 320 and the aft-facing surface 352 of the projection 350. The shape of the projection 350 within the radial slot 342 preferably corresponds to the shape of the radial slot 342 to fill the radial slot 342. The radial slot 342 and the aft-facing surface 352 of the projection 350, thus, preferably have the same shape with an appropriate gap 358 in an as assembled condition (e.g., of ambient temperature). In the as assembled condition, the gap 358 between the each of the side surfaces 354 of the projection 350 and each of the side walls 346 of the radial slot 342 may be, for example, from one thousandth of an inch (1 mil) to ten thousandths of an inch (10 mils), and more preferably from one thousandth of an inch (1 mil) to five thousandths of an inch (5 mils). Gaps 358 less than one thousandth of an inch (1 mil) may result in assembly issues such as interference. As noted above, the TBC 302 is applied over the combustor-facing surfaces of each of the shield flange 320 and the projection 350, and thus the TBC 302 preferably bridges the gap 358 to form a continuous coating. The maximum size of the gap 358 is thus preferably set to be a distance that can be bridged by the TBC 302, which may be based on the thickness of the TBC 302.

The radial slot 342 and the aft-facing surface 352 of the projection 350 may have any suitable shape, but, in some embodiments, the shape is selected for ease of manufacturing. As shown in FIG. 8A, the radial slot 342 and the aft-facing surface 352 of the projection 350 have a rectangular shape. As square corners may be stress concentrators, however, the radial slot 342 and the aft-facing surface 352 of the projection 350 may have rounded (or chamfered) corners, as shown in FIG. 8B. The shape of the radial slot 342 and the aft-facing surface 352 of the projection 350 shown in FIG. 8B may be referred to herein as a U-shaped slot.

FIG. 8C shows another shape of the radial slot 342 and the aft-facing surface 352 of the projection 350. The radial slot 342 and the aft-facing surface 352 of the projection 350 have a V-shape with the widest portion of the slot at the flange tip 325. To avoid stress concentrators in this embodiment, the point (or the narrowest portion) of the radial slot 342 and the aft-facing surface 352 of the projection 350 may be rounded.

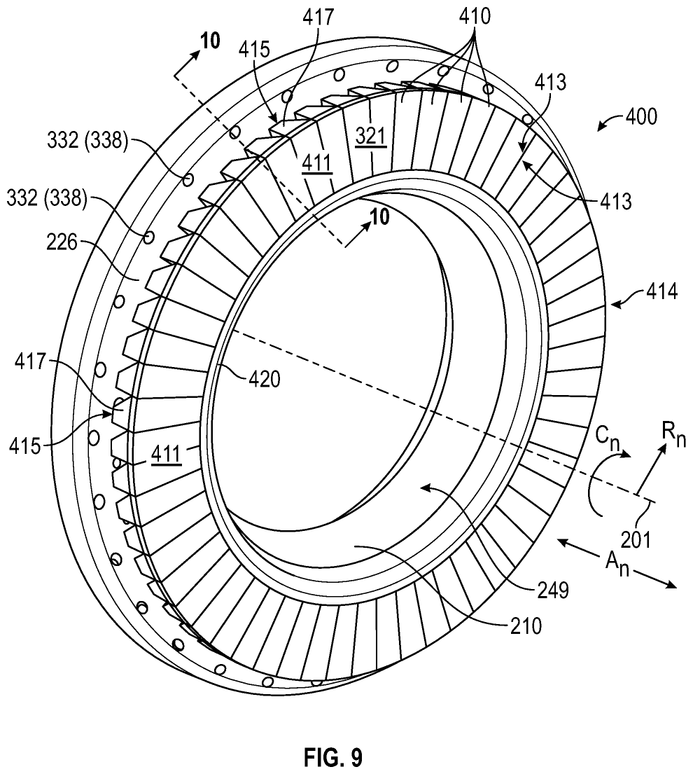

FIG. 9 is a schematic isometric view of an aft heat shield 400 according to another embodiment of the present disclosure. The aft heat shield 400 of this embodiment is similar to the aft heat shield 300 discussed above and may be positioned on the fuel injector 200 in a manner similar to the aft heat shield 300 discussed above. The same reference numerals will be used for components of the aft heat shield 400 of this embodiment that are the same or similar to the components of the aft heat shield 300 discussed above. The description of these components above also applies to this embodiment, and a detailed description of these components and other features, such as the positioning on the fuel injector 200 and materials of the aft heat shield, for example, is omitted here.

The aft heat shield 400 of this embodiment, similar to the aft heat shield 300 discussed above, includes a plurality of circumferential segments that can move and grow (i.e., increase in size) independently from each other, alleviating or preventing hoop stresses. As will be described in more detail below, each segment of the plurality of circumferential segments is a plate 410 in this embodiment. For clarity, only a portion of the plates 410 is indicated by a reference numeral in FIG. 9 and the following discussion. A plurality of the plates 410 are stacked together (arranged) to form an annular ring and then, an inner portion of each plate 410 is bonded to form the aft heat shield 400. Each plate 410 includes an aft-facing surface (referred to herein as a plate aft-facing surface 411), and, when the plates 410 are bonded together, the plate aft-facing surfaces 411 collectively form the aft-facing surface 321 of the aft heat shield 400. The plates 410 are thus preferably stacked such that the plate aft-facing surfaces 411 are substantially coplanar with each other, such as flush with each other.

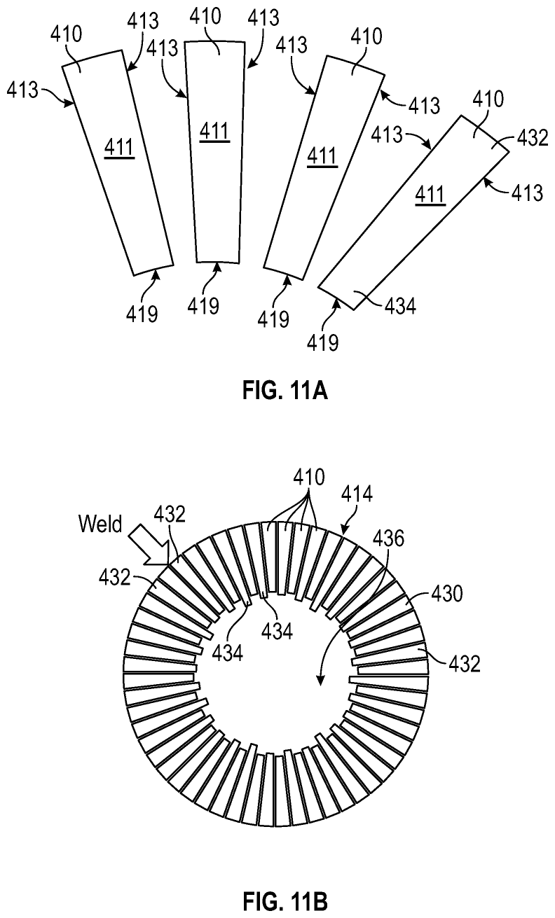

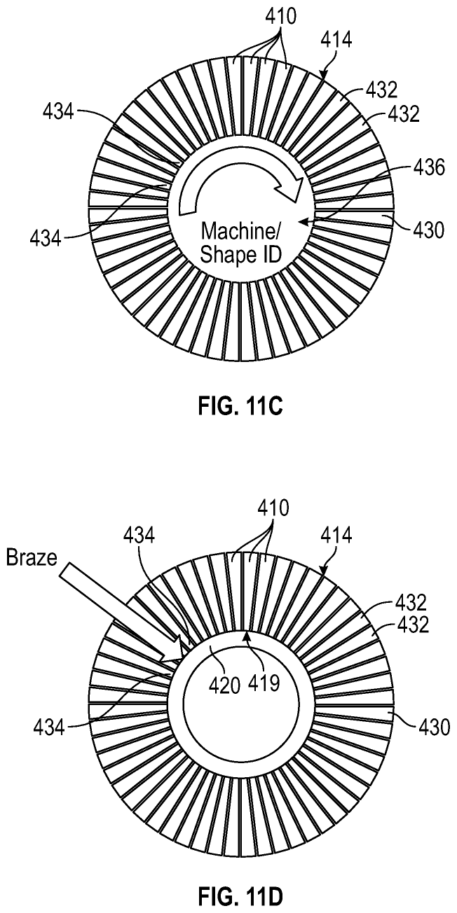

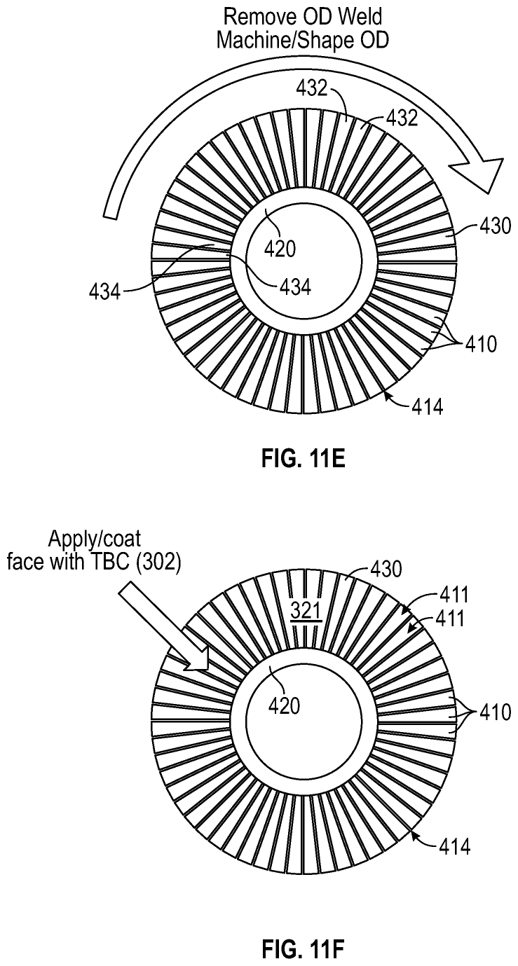

Each plate 410 also includes side walls 413 (see also FIG. 11A), and, in this embodiment, the side walls 413 of adjacent plates 410 abut each other. Alternatively, a small gap 414 may be formed between the side walls 413 of adjacent plates 410, the small gap 414 may be similar to the gap 414 between each of the side surfaces 354 of the projection 350 and each of the side walls 346 of the radial slot 342 discussed above. Each plate 410 is also axially tapered (tapered in a forward direction) with the plate aft-facing surface 411 being wider than a plate forward-facing surface 415, forming fins 417 for cooling the aft heat shield 400 in a manner similar to the fins 327 (FIGS. 7A and 7B) discussed above.

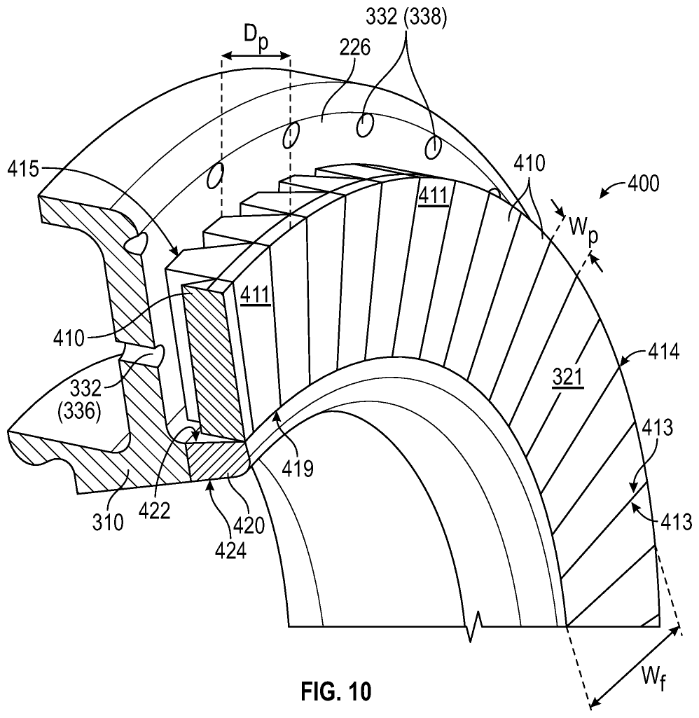

FIG. 10 is a partial cross-sectional view of the aft heat shield 400 of this embodiment taken along line 10-10 in FIG. 9. As noted above, an inner portion of each plate 410 is bonded to adjacent plates 410 to form the aft heat shield 400. In this embodiment, the aft heat shield 400 includes an inner ring 420, and an inner surface 419 of each plate 410 is bonded to the inner ring 420, and, more specifically, an outer surface 422 of the inner ring 420. As will be discussed further below, any suitable bonding process may be used, such as brazing, for example. In this embodiment, the inner ring 420 also includes an inner surface 424 that may be bonded to other portions of the aft heat shield 400 to form the inner wall 310.

Each plate 410 has a circumferential width Wₚ. The plate circumferential width Wₚ is the distance between the side walls 413, and when the plate 410 is tapered in the radial direction, the plate circumferential width Wₚ is the average width. The inventors have observed that, when the TBC 302 (FIGS. 7A and 7B) cracks from hoop stress, the TBC 302 typically occurs at four locations and thus, preferably, at least four plates 410 are used. Greater number of plates 410 provide additional benefits such as ease of assembly and improved heat transfer when the plate 410 is tapered in the forward direction to form fins 417, and thus, thirty-two plates 410 or more may be used. Plates 410 having a circumferential width Wₚ of ten thousandths of an inch (10 mils) or less may be difficult to assemble and thus the maximum number of plates may be the number of plates 410 that maintains the circumferential width Wₚ that is at least ten thousandths of an inch (10 mils). In this embodiment, the plate circumferential width Wₚ of each plate 410 is equal to the flange width W_{f} or less. More preferably, the plate circumferential width Wₚ is from ten percent (10%) to fifty percent (50%) of the flange width W_{f}, and more preferably from ten percent (10%) to thirty percent (30%). Also, in this embodiment, the plate circumferential width Wₚ is less than the distance that the plate 410 extends in the nozzle axial direction Aₙ (the plate axial depth Dₚ).

FIGS. 11A to 11F illustrate a method of forming the aft heat shield 400 of this embodiment. FIG. 11A is a first step, in which a plurality of the plates 410 are stacked together to form an annular ring 430 of stacked plates 410 (see FIG. 11B). In some embodiments, each of the plates 410 may also be radially tapered with an outer portion 432 (outer surface) of each plate 410 being wider than the inner surface 419 to enable stacking in the annular configuration. FIG. 11B is a second step, in which the annular ring 430 of stacked plates 410 are held together for further processing. Although the stacked plates 410 may held together for further processing by mechanical means, such as a fixture, the stacked plates 410 may held together by bonding. More specifically, the outer portions 432 of adjacent plates 410 may be bonded to each other using, for example, a fusion bonding process, such as welding or brazing. As this is a temporary bonding process, suitable temporary bonds may be used such as spot welding.

FIG. 11C is a third step. After the outer portions 432 of the plates 410 are bonded to each other, inner portions 434 of the plates 410 are machined to an inner diameter. As schematically illustrated in FIG. 11B, the inner portions 434 of the plate 410 may extend different distances into a hole 436 of the annular ring 430. Machining the inner portions 434 establishes a uniform inner diameter of the annular ring 430. By machining the inner portions 434, the plates 410 can be stacked and bonded in the previous steps with less precision, increasing the manufacturability of this aft heat shield 400.

In a fourth step, shown in FIG. 11D, the inner ring 420 is placed within the hole 436, and then, the inner surface 419 of each plate 410 is attached to the inner ring 420. In this embodiment, each plate 410 is fused to the inner ring 420 by a fusion bonding process, such as welding or brazing. Brazing is a process that avoids distortion of the plates 410 and my preferably be used where operating temperatures are lower than the brazing temperature of the braze used to attach each plate 410 to the inner ring 420.

The outer portion 432 is machined in a fifth step, as shown in FIG. 11E. The outer portion 432 is machined to remove the weld applied in the second step (FIG. 11B). Removing the weld removes the constraint on the outer portion 432 of each plate 410, allowing each plate 410 to move and to grow (i.e., increase in size) independently from each other. With the plates 410 free from constraint and attachment to each other on the outer portion 432, hoop stress can be alleviated or prevented, as discussed above.

After machining is complete, the TBC 302 is applied in a sixth step shown in FIG. 11F. More specifically, the plate aft-facing surfaces 411 collectively form the aft-facing surface 321 of the aft heat shield 400 and a suitable coating process is used to apply the TBC 302. Suitable coating processes include, for example, chemical vapor deposition or thermal spray techniques.

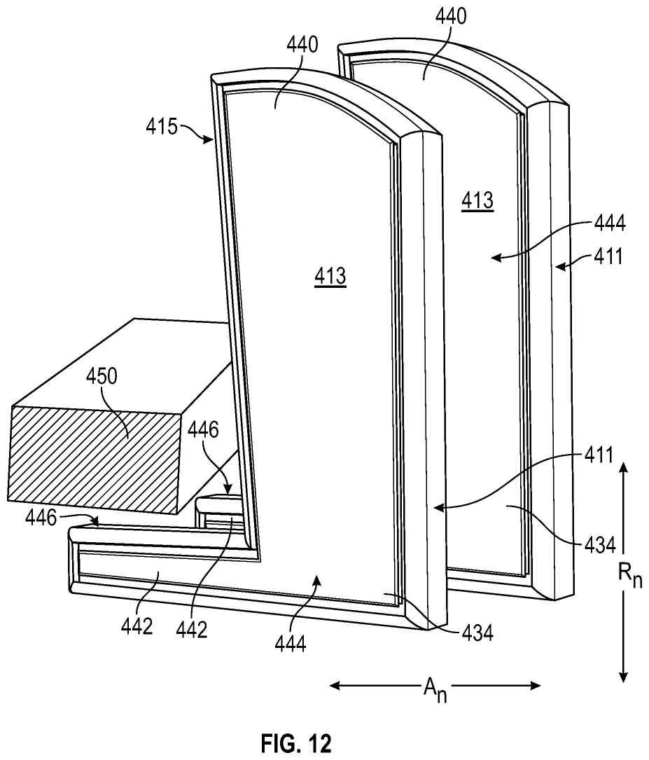

FIG. 12 is a partial cross-sectional view showing another plate 440 that may be used to form the heat shield shown in FIG. 9. The plate 440 of this embodiment is similar to the plate 410 discussed above. The same reference numerals will be used for components and features of the plate 440 of this embodiment that are the same as or similar to the components and features of the plate 410 discussed above. The description of the components and features of the plate 410 discussed above also applies to the plate 440 of this embodiment, and a detailed description of these components and features is omitted here. The plate 410 shown and described above has a generally rectangular cross section extending in the nozzle axial direction Aₙ and the nozzle radial direction Rₙ. Plates with other geometries may be used. The plate 440 of this embodiment has an L-shape with a leg 442 extending in the nozzle axial direction Aₙ. The leg 442 is located on the inner portion 434 of the plate 440 and extends toward the cold side (forward direction) from a rectangular portion 444 of the plate 440.

The leg 442 includes an outer surface in the radial direction (a radially outer surface 446). A ring 450 may be placed on the radially outer surface 446 of each plate 440, and the plates 440 joined together by fusion bonding, such as by brazing, to the ring 450, and in this context the ring 450 may be a braze ring 450. More specifically, the legs 442 of plate 440 are brazed to the ring 450.

The fuel injectors 200 (fuel nozzles) discussed herein include an annular aft heat shield (aft heat shield 300 or aft heat shield 400) having a TBC 302. These aft heat shields (aft heat shield 300 or aft heat shield 400) include a shield flange 320 that includes a plurality of circumferential segments that allow for thermal growth and deformation, reducing hoop stresses formed in the shield flange 320 during operation. By alleviating these hoop stresses, the aft heat shields (aft heat shield 300 or aft heat shield 400) discussed herein help prevent cracking of the TBC 302. Further aspects of the present disclosure are provided by the subject matter of the following clauses.

A heat shield for a combustor of a gas turbine engine, the heat shield comprising an annular ring having an axial direction, a radial direction, and a circumferential direction, the annular ring including a plurality of circumferential segments, each circumferential segment of the plurality of circumferential segments being disconnected from an adjacent circumferential segment of the plurality of circumferential segments to allow for thermal growth of each circumferential segment during operation of the combustor.

The heat shield of the preceding clause, wherein the annular ring includes a plurality of radial slots, adjacent circumferential segments of the plurality of circumferential segments being disconnected from each other by one of the radial slots of the plurality of radial slots.

The heat shield of any preceding clause, wherein the plurality of circumferential segments is two circumferential segments and the plurality of radial slots is two radial slots.

The heat shield of any preceding clause, wherein the radial slots are positioned one hundred eighty degrees from each other.

The heat shield of any preceding clause, wherein the plurality of circumferential segments is four circumferential segments and the plurality of radial slots is four radial slots.

The heat shield of any preceding clause, wherein the radial slots are positioned ninety degrees from each other.

The heat shield of any preceding clause, wherein the plurality of circumferential segments is eight circumferential segments and the plurality of radial slots is eight radial slots.

The heat shield of any preceding clause, wherein the radial slots are positioned forty-five degrees from each other.

The heat shield of any preceding clause, wherein the annular ring includes a radially outer edge, each radial slot extending inward from the radially outer edge.

The heat shield of any preceding clause, wherein the annular ring has a width in the radial direction, and each radial slot extends inward from the radially outer edge a distance that is less than the width of the annular ring in the radial direction.

The heat shield of any preceding clause, wherein each radial slot extends inward from the radially outer edge a distance that is from 10% percent to 100% percent of the width of the annular ring in the radial direction.

The heat shield of any preceding clause, wherein each radial slot has a width in the circumferential direction, the width in the circumferential direction being fifty mils to two hundred mils.

The heat shield of any preceding clause, wherein each radial slot has a width in the circumferential direction, the width in the circumferential direction being eighty-five mils to one hundred seventy-five mils.

The heat shield of any preceding clause, wherein the annular ring includes an inner ring portion.

The heat shield of any preceding clause, wherein each circumferential segment of the plurality of circumferential segments extends radially outward from the inner ring portion.

The heat shield of any preceding clause, wherein the inner ring portion is an inner portion of the annular ring that is free from the plurality of radial slots.

The heat shield of any preceding clause, wherein the annular ring is a portion of a flange.

The heat shield of any preceding clause, further comprising in inner wall, the flange being attached to the inner wall.

A fuel nozzle for a gas turbine engine, the fuel nozzle comprising a fuel nozzle tip including a distal end, and the heat shield of any preceding clause attached to the distal end of the fuel nozzle tip.

The fuel nozzle of the preceding clause, wherein the distal end of the fuel nozzle tip includes a hot-side surface that has a plurality of projections extending therefrom, each projection of the plurality of projections extending into a corresponding one of the plurality of radial slots.

The fuel nozzle of any preceding clause, wherein the annular ring includes a hot-side surface.

The fuel nozzle of the preceding clause, wherein the hot-side surface of the annular ring is a planar surface.

The fuel nozzle of the preceding clause, wherein each projection of the plurality of projections includes a hot-side surface, each projection of the plurality of projections extending into the corresponding one of the plurality of radial slots such that the hot-side surface of the projection is substantially coplanar with the hot-side surface of the annular ring.

The fuel nozzle of the preceding clause, wherein each projection of the plurality of projections includes a hot-side surface, each projection of the plurality of projections extending into the corresponding one of the plurality of radial slots such that the hot-side surface of the projection is flush with the hot-side surface of the annular ring.

The fuel nozzle of the preceding clause, further comprising a thermal barrier coating formed on the hot-side surface of the annular ring and the hot-side surfaces of the plurality of projections.

The fuel nozzle of the preceding clause, wherein the thermal barrier coating is a ceramic.

The fuel nozzle of the preceding clause, wherein each projection of the plurality of projections has a rectangular cross section in a circumferential plane.

The fuel nozzle of the preceding clause, wherein each projection of the plurality of projections is axially tapered.

The fuel nozzle of the preceding clause, wherein each projection of the plurality of projections includes a proximal portion proximal to the hot-side surface of the fuel nozzle tip and a distal portion, each projection of the plurality of projections being tapered such that the proximal portion is wider than the distal portion.

The fuel nozzle of the preceding clause, wherein each radial slot of the plurality of radial slots is tapered.

The fuel nozzle of the preceding clause, wherein the annular ring includes a hot-side surface and a cold-side surface, and each radial slot of the plurality of radial slots is tapered such that the width of the radial slot at the hot-side surface of the annular ring is narrower than the width of the radial slot at the cold-side surface of the annular ring.

The fuel nozzle of the preceding clause, wherein each projection of the plurality of projections includes a hot-side surface having a shape, and each radial slot of the plurality of radial slots has a corresponding shape in the radial direction at the hot-side surface of the annular ring.

The fuel nozzle of the preceding clause, wherein the shape of the hot-side surface of each projection of the plurality of projections is rectangular.

The fuel nozzle of the preceding clause, wherein the shape of the hot-side surface of each projection of the plurality of projections is a U-shape.

The fuel nozzle of the preceding clause, wherein the shape of the hot-side surface of each projection of the plurality of projections is a V-shape.

The fuel nozzle of the preceding clause, wherein the narrowest portion of the V-shape is rounded.

The heat shield of any preceding clause, further comprising a plurality of plates arranged to form the annular ring, wherein each circumferential segment of the plurality of circumferential segments is a plate of the plurality of plates.

The heat shield of any preceding clause, wherein each plate of the plurality of plates is tapered in a radial direction.

The heat shield of any preceding clause, wherein each plate of the plurality of plates includes at least one side wall.

The heat shield of any preceding clause, wherein the at least one side wall of each plate of the plurality of plates abuts the at least one side wall of an adjacent plate.

The heat shield of any preceding clause, wherein a gap is formed between the at least one side wall of each plate of the plurality of plates and the at least one side wall of an adjacent plate.

The heat shield of the preceding clause, wherein the gap is from 1 mil to 10 mils.

The heat shield of any preceding clause, wherein each plate of the plurality of plates is axially tapered.

The heat shield of any preceding clause, wherein each plate of the plurality of plates includes a plate hot-side surface, the plate hot-side surfaces collectively forming a hot-side surface of the annular ring.

The heat shield of any preceding clause, wherein the plate hot-side surfaces are substantially coplanar with each other.

The heat shield of any preceding clause, wherein the plate hot-side surfaces are flush with each other.

The heat shield of any preceding clause, further comprising a thermal barrier coating formed on the hot-side surface of the annular ring.

The heat shield of any preceding clause, wherein the thermal barrier coating is a ceramic.

The heat shield of any preceding clause, wherein each plate of the plurality of plates is shaped to form fins on a side of the annular ring opposite the hot-side surface of the annular ring.

The heat shield of any preceding clause, wherein each plate of the plurality of plates includes an inner portion and an outer portion, the outer portion of each plate being free from attachment to the outer portions of adjacent plates.

The heat shield of any preceding clause, wherein the inner portion of each plate of the plurality of plates is bonded.

The heat shield of any preceding clause, wherein each plate of the plurality of plates is L-shaped having a leg extending from the inner portion of each plate of the plurality of plates in the axial direction.

The heat shield of any preceding clause, wherein the legs of each plate of the plurality of plates are bonded to a ring.

The heat shield of any preceding clause, wherein each leg of each plate of the plurality of plates includes an upper surface, the upper surface of each leg being bonded to the ring.

The heat shield of any preceding clause, wherein the upper surface of each leg is brazed to the ring.

The heat shield of any preceding clause, further comprising an inner ring, wherein the inner portion of each plate of the plurality of plates is bonded to the inner ring.

The heat shield of any preceding clause, wherein each plate of the plurality of plates includes an inner surface, the inner surface being bonded to the inner ring.

The heat shield of any preceding clause, wherein the inner ring includes an outer surface, the inner surface of each plate of the plurality of plates being bonded to the outer surface of the inner ring.

The heat shield of any preceding clause, wherein the inner surface of each plate of the plurality of plates is brazed to the outer surface of the inner ring.

The heat shield of any preceding clause, wherein each plate of the plurality of plates has a circumferential width, and the annular ring has a radial width, the circumferential width of each plate of the plurality of plates being less than the radial width of the annular ring.

The heat shield of any preceding clause, wherein the circumferential width of each plate of the plurality of plates is from ten percent (10%) to fifty percent (50%) of the radial width of the annular ring.

The heat shield of any preceding clause, wherein the circumferential width of each plate of the plurality of plates is from ten percent (10%) to thirty percent (30%) of the radial width of the annular ring.

The heat shield of any preceding clause, wherein each plate of the plurality of plates has an axial depth, the circumferential width of each plate of the plurality of plates being less than the axial depth.

A fuel nozzle for a gas turbine engine, the fuel nozzle comprising a fuel nozzle tip including a distal end, and the heat shield of any preceding clause attached to the distal end of the fuel nozzle tip.

The fuel nozzle of any preceding clause, wherein the distal end of the fuel nozzle tip includes a hot-side surface, and the fuel nozzle further comprises a plurality of cooling holes formed in the hot-side surface of the fuel nozzle tip.

The fuel nozzle of any preceding clause, wherein the annular ring includes a cold-side surface, and the plurality of cooling holes are arranged in the hot-side surface of the fuel nozzle tip to direct cooling air discharged though each of the cooling holes of the plurality of cooling holes toward the cold-side surface of the annular ring.

The fuel nozzle of any preceding clause, further comprising a plurality of fins formed on the cold-side surface of the annular ring.

The fuel nozzle of any preceding clause, wherein at least a portion of the cooling holes of the plurality of cooling holes is arranged in an inner array.

The fuel nozzle of any preceding clause, wherein the cooling holes of the inner array are aligned in the circumferential direction.

The fuel nozzle of any preceding clause, wherein the cooling holes of the inner array oriented in the nozzle axial direction parallel to an axis of the fuel nozzle.

The fuel nozzle of any preceding clause, wherein at least a portion of the cooling holes of the plurality of cooling holes is arranged in an outer array.

The fuel nozzle of any preceding clause, wherein the cooling holes of the outer array are aligned in the circumferential direction.

The fuel nozzle of any preceding clause, wherein the annular ring includes a radially outer edge and the cooling holes of the outer array are oriented to direct cooling air towards the radially outer edge.

A method of forming an annular heat shield for a combustor. The method comprises stacking a plurality of plates together to form an annular ring having a hole, machining an inner portion of the plurality of plates to form an inner diameter of the hole of the annular ring, placing an inner ring into the hole of the annular ring, and bonding an inner portion of each plate of the plurality of plates to the inner ring.

The method of the previous clause, further comprising bonding an outer portion of each plate to each other prior to machining the inner portion of the plurality of plates, and removing the bond on the outer portion of each plate after machining the inner portion of the plurality of plates.

The method of any previous clause, wherein removing the bond on the outer portion of each plate includes machining the outer portion of each plate to remove the bond.

The method of any previous clause, wherein the bond on the outer portion of each plate is a fusion bond.

The method of any previous clause, wherein bonding an outer portion of each plate to each other includes welding and the fusion bond is a weld.

The method of any previous clause, wherein bonding the inner portion of each plate of the plurality of plates to the inner ring includes forming a fusion bond.

The method of any previous clause, wherein bonding the inner portion of each plate of the plurality of plates to the inner ring includes brazing.

The method of any previous clause, wherein machining an inner portion of the plurality of plates forms an inner surface of each plate of the plurality of plates and bonding the inner portion of each plate of the plurality of plates to the inner ring includes bonding the inner surface of each plate of the plurality of plates to the inner ring.

The method of any previous clause, wherein the inner ring includes an outer surface and bonding the inner portion of each plate of the plurality of plates to the inner ring includes bonding the inner surface of each plate of the plurality of plates to the outer surface of the inner ring.

The method of any previous clause, wherein bonding the inner portion of each plate of the plurality of plates to the inner ring includes brazing the inner surface of each plate of the plurality of plates to the outer surface of the inner ring.

The method of any previous clause, wherein each plate of the plurality of plates is tapered in a radial direction.

The method of any previous clause, wherein each plate of the plurality of plates includes at least one side wall.

The method of any previous clause, wherein stacking the plurality of plates together includes positioning the plates such that the at least one side wall of each plate of the plurality of plates abuts the at least one side wall of an adjacent plate.

The method of any previous clause, wherein stacking the plurality of plates together includes positioning the plates such that a gap is formed between the at least one side wall of each plate of the plurality of plates and the at least one side wall of an adjacent plate. The method of any previous clause, wherein a gap is from 1 mil to 10 mils.

The method of any previous clause, wherein stacking the plurality of plates together includes positioning a plate hot-side surface of each plate of the plurality of plates such that the plate hot-side surfaces collectively form a hot-side surface of the annular ring.

The method of any previous clause, further comprising coating the hot-side surface of the annular ring with a thermal barrier coating.

The method of any previous clause, wherein the thermal barrier coating is a ceramic.

Although the foregoing description is directed to the preferred aspects, other variations and modifications will be apparent to those skilled in the art and may be made without departing from the spirit or the scope of the disclosure. Moreover, features described in connection with one aspect may be used in conjunction with other aspects, even if not explicitly stated above.

1. A heat shield for a combustor of a gas turbine engine, the heat shield comprising:
an annular ring having an axial direction, a radial direction, and a circumferential direction, the annular ring including a plurality of circumferential segments, each circumferential segment of the plurality of circumferential segments being disconnected from an adjacent circumferential segment of the plurality of circumferential segments to allow for thermal growth of each circumferential segment during operation of the combustor.

2. The heat shield of claim 1, wherein the annular ring includes a plurality of radial slots, adjacent circumferential segments of the plurality of circumferential segments being disconnected from each other by one of the radial slots of the plurality of radial slots.

3. The heat shield of claim 2, wherein the annular ring has a width in the radial direction and includes a radially outer edge, each radial slot extending inward from the radially outer edge a distance that is less than the width of the annular ring in the radial direction.

4. The heat shield of claim 3, wherein the annular ring includes an inner ring portion, the inner ring portion being an inner portion of the annular ring that is free from the plurality of radial slots, each circumferential segment of the plurality of circumferential segments extending radially outward from the inner ring portion.

5. A fuel nozzle for a gas turbine engine, the fuel nozzle comprising:
a fuel nozzle tip including a distal end; and
the heat shield of claim 2 attached to the distal end of the fuel nozzle tip,
wherein the distal end of the fuel nozzle tip includes a hot-side surface that has a plurality of projections extending therefrom, each projection of the plurality of projections extending into a corresponding one of the plurality of radial slots.

6. The fuel nozzle of claim 5, wherein each projection of the plurality of projections includes a proximal portion proximal to the hot-side surface of the fuel nozzle tip and a distal portion, each projection of the plurality of projections being tapered such that the proximal portion is wider than the distal portion, and
wherein the annular ring includes a hot-side surface and a cold-side surface, each radial slot of the plurality of radial slots being tapered such that the width of the radial slot at the hot-side surface of the annular ring is narrower than the width of the radial slot at the cold-side surface of the annular ring.

7. The fuel nozzle of claim 5, wherein the annular ring includes a hot-side surface that is a planar surface, and
wherein each projection of the plurality of projections includes a hot-side surface, each projection of the plurality of projections extending into the corresponding one of the plurality of radial slots such that the hot-side surface of the projection is substantially coplanar with the hot-side surface of the annular ring.

8. The fuel nozzle of claim 7, further comprising a thermal barrier coating formed on the hot-side surface of the annular ring and the hot-side surfaces of the plurality of projections.

9. The heat shield of claim 1, further comprising a plurality of plates arranged to form the annular ring, wherein each circumferential segment of the plurality of circumferential segments is a plate of the plurality of plates.

10. The heat shield of claim 9, wherein each plate of the plurality of plates includes a plate hot-side surface that collectively form a hot-side surface of the annular ring and are substantially coplanar with each other, a thermal barrier coating being formed on the hot-side surface of the annular ring.

11. The heat shield of claim 9, wherein each plate of the plurality of plates includes an inner portion and an outer portion, the outer portion of each plate being free from attachment to the outer portions of adjacent plates.

12. The heat shield of claim 11, wherein each plate of the plurality of plates is L-shaped having a leg extending from the inner portion of each plate of the plurality of plates in the axial direction, the legs of each plate of the plurality of plates being bonded to a ring.

13. The heat shield of claim 11, wherein the inner portion of each plate of the plurality of plates is bonded.

14. The heat shield of claim 13, further comprising an inner ring, wherein the inner portion of each plate of the plurality of plates is bonded to the inner ring.

15. The heat shield of claim 14, wherein each plate of the plurality of plates includes an inner surface and the inner ring includes an outer surface, the inner surface of each plate of the plurality of plates being brazed to the outer surface of the inner ring.

16. A method of forming an annular heat shield for a combustor, the method comprising:
stacking a plurality of plates together to form an annular ring having a hole;
machining an inner portion of the plurality of plates to form an inner diameter of the hole of the annular ring;
placing an inner ring into the hole of the annular ring; and
bonding an inner portion of each plate of the plurality of plates to the inner ring.

17. The method of claim 16, further comprising:
bonding an outer portion of each plate to each other prior to machining the inner portion of the plurality of plates; and
machining the outer portion of each plate to remove a bond on the outer portion of each plate after machining the inner portion of the plurality of plates.

18. The method of claim 16, wherein machining an inner portion of the plurality of plates forms an inner surface of each plate of the plurality of plates, and bonding the inner portion of each plate of the plurality of plates to the inner ring includes brazing the inner surface of each plate of the plurality of plates to the inner ring.

19. The method of claim 16, wherein stacking the plurality of plates together includes positioning a plate hot-side surface of each plate of the plurality of plates such that the plate hot-side surfaces collectively form a hot-side surface of the annular ring.

20. The method of claim 19, further comprising coating the hot-side surface of the annular ring with a thermal barrier coating.
